(19) United States
(12) Patent Application Publication
(10) Pub. No.: US 2023/0318090 A1
(43) Pub. Date: Oct. 5, 2023

(54) HEAT STORAGE MATERIAL

(71) Applicant: HONDA MOTOR CO., LTD., Tokyo (JP)

(72) Inventors: Shoji TAKAHASHI, Saitama (JP); Yushi FUJINAGA, Saitama (JP); Mitsumasa SORAZAWA, Saitama (JP); Takayuki SAKATA, Saitama (JP); Hideki MATSUDA, Saitama (JP)

(21) Appl. No.: 18/190,985

(22) Filed: Mar. 28, 2023

(30) Foreign Application Priority Data
Mar. 30, 2022 (JP) 2022-055589

(51) Int. Cl. H01M 10/659; H01M 10/0525; H01M 10/653; H01M 10/617

(52) U.S. Cl. CPC H01M 10/659; H01M 10/0525; H01M 10/653; H01M 10/617

(57) ABSTRACT

An object is to sufficiently lower the melting point of a heat storage material that includes sodium acetate trihydrate as a main component and to sufficiently narrow the range of a melting peak while ensuring a sufficient heat storage density. A heat storage material contains sodium acetate trihydrate that serves as a main component 21 and a melting point adjuster that is any one of potassium nitrate, potassium chloride or sodium nitrate. The content of the melting point adjuster in the heat storage material is equal to or greater than 10% by weight. The present inventors have confirmed that by setting the content of the melting point adjuster to be equal to or greater than 10% by weight, the range of a melting peak serving as a melting temperature range can be sufficiently narrowed.

This application is based on and claims the benefit of priority from Japanese Patent Application 2022-055589, filed on 30 Mar. 2022, the content of which is incorporated herein by reference.

### BACKGROUND OF THE INVENTION

### Field of the Invention

The present invention relates to heat storage materials which store latent heat.

### Related Art

In recent years, for example, in terms of reducing adverse effects on the global environment by reducing carbon dioxide emissions, electric vehicles such as EVs and HEVs have been becoming more widespread. In electric vehicles and the like, batteries such as lithium-ion batteries are installed.
Patent Document 1: Japanese Patent No. 3442155

### SUMMARY OF THE INVENTION

In general, when the temperature of a battery is excessively high, the battery is discharged and degraded. On the other hand, when the temperature is excessively low, the battery cannot output a sufficient voltage. Hence, for the battery, it is important to control the temperature.

The present inventors have considered that a heat storage material is used to control the temperature of a battery. Specifically, for example, when the temperature of the battery is high, the heat storage material is melted by the heat of the battery, and thus latent heat is stored in the heat storage material, and an increase in the temperature of the battery is suppressed by heat absorption at that time.

In terms of suppressing the degradation of the battery, it is often required to control the temperature of the battery to 60° C. or less. Although sodium acetate trihydrate is promising as the heat storage material because of its high heat storage density, the melting point thereof is as high as 58° C., and thus a temperature suppression effect can be achieved only immediately before 60° C. is reached. Hence, it is necessary to add a melting point adjuster which lowers the melting point. However, when another material is added to sodium acetate trihydrate as described above, though the melting point is lowered, a melting peak serving as a melting temperature range is widened, with the result that the melting peak is unlikely to be within a range of equal to or less than 60° C. Moreover, when another material is added to sodium acetate trihydrate as described above, the heat storage density of sodium acetate trihydrate may be lowered.

The present invention is made in view of the circumstances described above, and an object of the present invention is to sufficiently lower the melting point of a heat storage material which includes sodium acetate trihydrate as a main component and to sufficiently narrow the range of a melting peak while ensuring a sufficient heat storage density.

The present inventors have found that by blending 10% by weight or more of potassium nitrate, potassium chloride or sodium nitrate in a heat storage material including sodium acetate trihydrate as a main component, it is possible to sufficiently lower the melting point and to sufficiently narrow the range of a melting peak while ensuring a sufficient heat storage capacity, and have achieved the present invention. The present invention provides heat storage materials having configurations of (1) to (4) below.

(1) A heat storage material including: sodium acetate trihydrate that serves as a main component; and
a melting point adjuster that is any one of potassium nitrate, potassium chloride or sodium nitrate,
the content of the melting point adjuster being equal to or greater than 10% by weight.

The present inventors have confirmed that by adding potassium nitrate, potassium chloride or sodium nitrate to sodium acetate trihydrate, it is possible to sufficiently lower the melting point while ensuring a sufficient heat storage capacity. Moreover, the present inventors have confirmed that by setting the content of the melting point adjuster to 10% by weight or more, the range of a melting peak serving as a melting temperature range is sufficiently narrowed. Hence, in the present configuration, it is possible to sufficiently lower the melting point and to sufficiently narrow the range of the melting peak while ensuring a sufficient heat storage density.

(2) The heat storage material described in (1) above, in which the melting point adjuster is the potassium nitrate.

The present inventors have confirmed that among potassium nitrate, potassium chloride and sodium nitrate, when the potassium nitrate is adopted as the melting point adjuster, the melting point is minimized. Hence, in the present configuration, it is possible to more efficiently set the melting point low.

(3) The heat storage material described in (2) above, in which the content of the potassium nitrate is equal to or greater than 20% by weight.

The present inventors have confirmed that when the content of the potassium nitrate is set to 20% by weight or more, the range of the melting peak is more sufficiently narrowed as compared with a case where the content of the potassium nitrate is equal to or greater than 10% by weight and less than 20% by weight. Hence, in the present configuration, it is possible to more satisfactorily narrow the range of the melting peak.

(4) The heat storage material described in any one of (1) to (3) above, in which the heat storage material is a battery temperature rise suppression material that absorbs the heat of a battery to melt, thereby storing latent heat and suppressing an increase in the temperature of the battery.

As described previously, it is often required to control the temperature of the battery to 60° C. or less. In this regard, according to the configuration of (1) described above and cited by the present configuration, it is possible, as described above, to sufficiently lower the melting point and to sufficiently narrow the range of the melting peak, whereby the melting peak is easily made within a range of equal to or less than 60° C. and the temperature of the battery is easily controlled to 60° C. or less. Hence, the configuration of (1) described above can be effectively utilized.

(5) The heat storage material described in (4) above, in which the battery is a lithium-ion battery that includes a liquid electrolyte.

Among batteries, in particular, lithium-ion batteries that include a liquid electrolyte often require temperature control of 60° C. or less. Hence, the configuration of (1) described above can be more effectively utilized.

As described above, according to the invention of (1) described above, it is possible to sufficiently lower the melting point and to sufficiently narrow the range of a melting peak while ensuring a sufficient heat storage density. Furthermore, in each of the configurations of (2) to (5) above which cite (1) described above, an additional effect can be obtained.

### BRIEF DESCRIPTION OF THE DRAWINGS

FIG. 1 is a configuration diagram showing the heat storage material of the present embodiment and its surroundings;

FIG. 2 is a graph showing the properties of heat storage materials including different melting point adjusters; and

FIG. 3 is a graph showing a relationship between a temperature and a heat flow for each of the amounts of potassium nitrate added.

### DETAILED DESCRIPTION OF THE INVENTION

An embodiment of the present invention will be described below with reference to drawings. However, the present invention is not limited to the embodiment described above at all, and can be changed and practiced without departing from the spirit of the present invention.

### First Embodiment

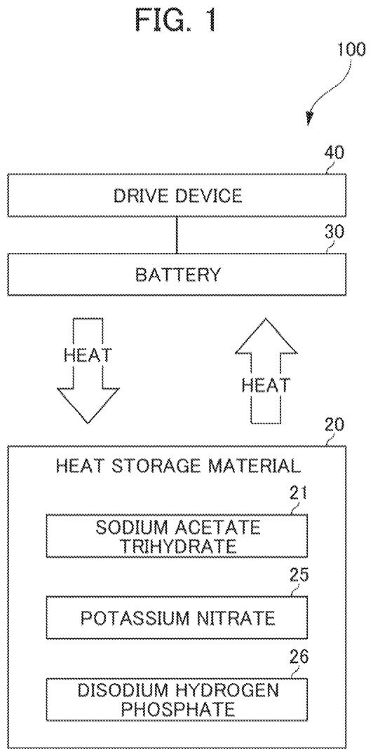

FIG. 1 is a schematic diagram showing the heat storage material 20 of the present embodiment. The heat storage material 20 is installed in an electric vehicle 100 such as an EV or a HEV. In the electric vehicle 100, a drive device 40 such as a motor which causes the electric vehicle 100 to travel and a battery 30 which supplies power to the drive device 40 are installed. The battery 30 is a lithium-ion battery which includes a liquid electrolyte. Hence, it is required to control the temperature of the battery 30 to 60° C. or less.

The heat storage material 20 is provided for the battery 30, and by heat exchange with the battery 30, suppresses an increase in the temperature of the battery 30. The heat storage material 20 contains sodium acetate trihydrate which serves as a main component 21, potassium nitrate which serves as a melting point adjuster 25 and disodium hydrogen phosphate which serves as a supercooling prevention material 26.

The sodium acetate trihydrate absorbs the heat of the battery 30 to melt so as to store latent heat and suppress an increase in the temperature of the battery 30. The sodium acetate trihydrate solidifies at low temperature to discharge the latent heat. The potassium nitrate lowers the melting point of the heat storage material 20 which includes the sodium acetate trihydrate as the main component. Sodium carbonate serves as a core for the solidification in the heat storage material 20 when the heat storage material 20 is at a low temperature, thereby promoting the solidification, and preventing the heat storage material 20 from supercooling while maintaining a state of liquid.

In the heat storage material 20, the content of the potassium nitrate is equal to or greater than 10% by weight and more preferably equal to or greater than 20% by weight, the content of the disodium hydrogen phosphate is about 1% by weight and the remainder is the sodium acetate trihydrate.

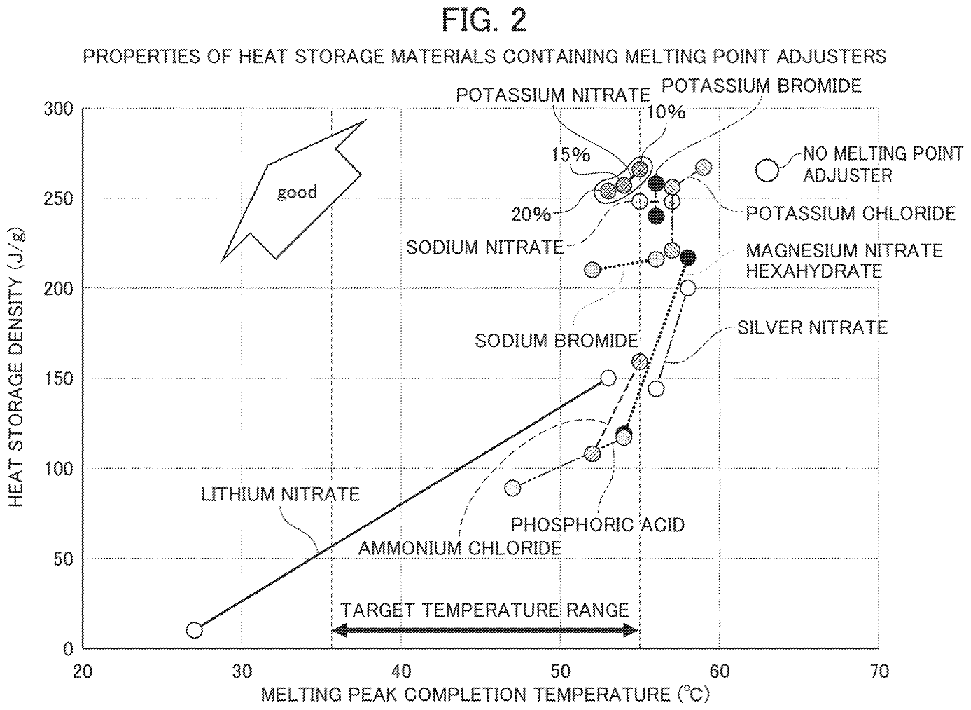

Then, with reference to FIG. 2, the reason why the potassium nitrate is adopted as the melting point adjuster 25 will be described.

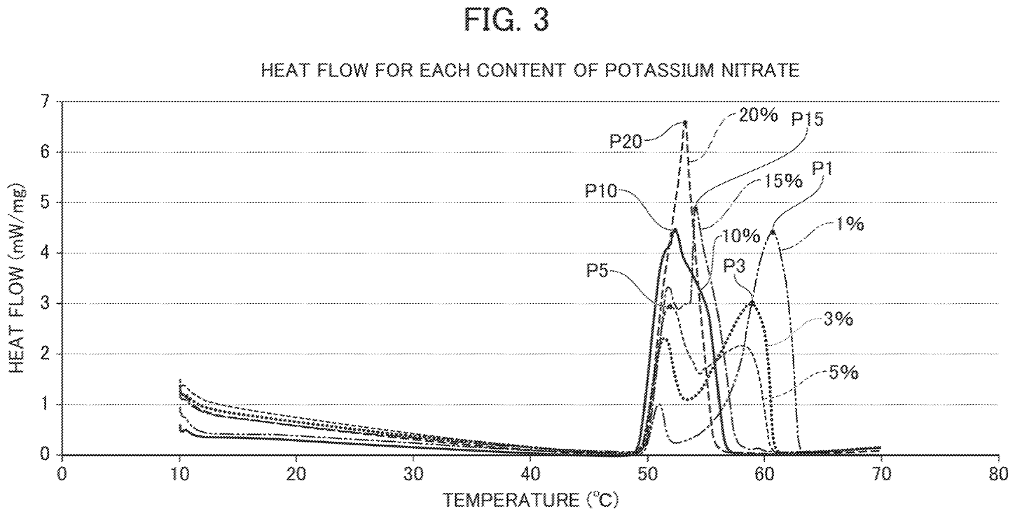

FIG. 2 is a graph showing the results of tests when in the heat storage material including the sodium acetate trihydrate as the main component, the potassium nitrate and other substances were used as the melting point adjuster 25. Hereinafter, the amount of latent heat per unit weight of the heat storage material is referred to as the “heat storage density”. The amount of absorption and release of heat per unit of time, which associated with a temperature increase, a temperature decrease or a phase transformation of the heat storage material per unit weight, is referred to as the “heat flow”. As shown in FIG. 3 which will be described later, the convex heat flow increase behavior caused in the melting temperature range of the heat storage material is referred to as the “melting peak”. A temperature at which the melting reaction of the heat storage material is completed and the behavior returns to the behavior before the occurrence of the melting peak is referred to as the “melting peak completion temperature”. The melting peak completion temperature is specifically a temperature at the intersection of the extrapolated line of a heat flow decrease behavior in the latter half of the melting peak and a line connecting two points before and after the melting peak.

The graph of FIG. 2 shows the melting peak completion temperature and the heat storage density for each of the heat storage materials including the different melting point adjusters. Table 1 below shows original data for the graph of FIG. 2.

TABLE 1

| | | Melting | |
|---|---|---|---|
| | | peak | Melting |
| Melting | Added | completion | latent |
| point | amount | temperature | heat |
| adjuster | (wt. %) | (° C.) | (J/g) |
| None | — | 63 | 265 |
| Lithium | 10 | 53 | 150 |
| nitrate | 20 | 27 | 10 |
| Sodium | 10 | 57 | 248 |
| nitrate | 20 | 55 | 248 |
| Magnesium nitrate | 10 | 58 | 217 |
| hexahydrate | 20 | 54 | 119 |
| Potassium | 1 | 59 | 267 |
| chloride | 5 | 57 | 256 |
| | 10 | 57 | 221 |
| | 20 | 56 | 215 |
| Sodium | 10 | 56 | 216 |
| bromide | 20 | 52 | 210 |
| Potassium | 10 | 55 | 266 |
| nitrate | 15 | 54 | 257 |
| | 20 | 53 | 254 |
| Silver | 10 | 58 | 200 |
| nitrate | 20 | 56 | 144 |
| Phosphoric | 10 | 54 | 117 |
| acid | 20 | 47 | 89 |
| Potassium | 10 | 56 | 258 |
| bromide | 20 | 56 | 240 |
| Ammonium | 10 | 55 | 159 |
| chloride | 20 | 52 | 108 |

It is found from the graph of FIG. 2 that when the potassium nitrate is used as the melting point adjuster of the heat storage material, as compared with cases where the other substances are used as the melting point adjuster, the heat storage density is increased and the melting peak completion temperature falls in a target temperature range. Here, the “target temperature” is equal to or less than 55° C. Hence, from the viewpoint of the heat storage density and the melting peak, that is, from the viewpoint of sufficiently lowering the melting point while ensuring a sufficient heat storage density, potassium nitrate is expected to be the most promising melting point adjuster. Therefore, in the present embodiment, as described above, potassium nitrate is adopted as the melting point adjuster.

Then, with reference to FIG. 3, the reason why the content of potassium nitrate is set to 10% by weight or more, and more preferably set to 20% by weight or more will be described.

FIG. 3 is a graph showing a relationship between the temperature and the heat flow for each of the contents of the potassium nitrate when the potassium nitrate was used as the melting point adjuster in the heat storage material including the sodium acetate trihydrate as the main component. Specifically, the values of “1%”, “3%”, “5%”, “10%”, “15%” and “20%” in FIG. 3 refer to the contents of the potassium nitrate.

Table 2 below shows details in each of cases in FIG. 3. Specifically, for example, the curve of “1%” shown in FIG. 3 shows the case of the top row in Table 2, that is, the case where the sodium acetate trihydrate solution was “98”% by weight, the potassium nitrate was “1”% by weight and the disodium hydrogen phosphate was “1”% by weight. For example, the curve of “3%” shown in FIG. 3 shows the case of the second row from the top of Table 2, that is, the case where the sodium acetate trihydrate solution was “96”% by weight, the potassium nitrate was “3”% by weight and the disodium hydrogen phosphate was “1”% by weight.

TABLE 2

| Sodium | | Disodium |
|---|---|---|
| acetate | Potassium | hydrogen |
| trihydrate | nitrate | phosphate |
| 98 | 1 | 1 |
| 96 | 3 | 1 |
| 94 | 5 | 1 |
| 89 | 10 | 1 |
| 84 | 15 | 1 |
| 79 | 20 | 1 |

Parts of the heat flows which protrude upward in the graph of FIG. 3 show the melting peaks, and “P1”, “P3”, “P5”, “P10”, “P15” and “P20” respectively show the apexes of the melting peaks when the contents of the potassium nitrate were 1%, 3%, 5%, 10%, 15% and 20%. It is found from the graph that as compared with the cases where the contents of the potassium nitrate were 1%, 3% and 5%, in the cases where the contents of the potassium nitrate were 10%, 15% and 20%, the ranges of the melting peaks were significantly narrowed. Hence, it is estimated that when the content of the potassium nitrate is equal to or greater than 10%, the range of the melting peak of the melting point is narrowed.

Specifically, it is found that in the curves of 1%, 3% and 5%, that is, in the cases where the content of the potassium nitrate was equal to or less than 5%, the melting peaks were widened to within a range of 60° C. or more. On the other hand, it is found that in the curves of 10%, 15% and 20%, that is, in the cases where the content of the potassium nitrate was equal to or greater than 10%, the melting peaks were within a range of equal to or less than 60° C. Hence, it is estimated that when the content of the potassium nitrate is equal to or greater than 10% by weight, the melting peak is within a range of equal to or less than 60° C. Furthermore, among the cases of 10%, 15% and 20%, in the case of 20%, in particular, the range of the melting peak was significantly narrowed.

Therefore, in the present embodiment, as described above, the content of potassium nitrate is set to 10% by weight or more, and more preferably set to 20% by weight or more. Although the upper limit of the content of the potassium nitrate is not particularly limited, for example, the content of the potassium nitrate is preferably equal to or less than 40% by weight and more preferably equal to or less than 30% by weight so that the heat storage density of the heat storage material 20 is prevented from being lowered by an excess of the potassium nitrate.

The configurations and effects of the present embodiment will be summarized below.

As shown in FIG. 2 and the like, when in the heat storage material including the sodium acetate trihydrate as the main component, the potassium nitrate is used as the melting point adjuster, it is possible to sufficiently lower the melting point while sufficiently maintaining the heat storage density of the heat storage material. Moreover, as shown in FIG. 3 and the like, when the content of potassium nitrate is set to 10% by weight or more, the range of the melting peak serving as the melting temperature range is sufficiently narrowed. In this regard, in the present embodiment, the melting point adjuster is potassium nitrate, the content thereof is equal to or greater than 10% by weight, thereby capable of sufficiently lowering the melting point and sufficiently narrowing the range of the melting peak while ensuring a sufficient heat storage density. In this way, the melting peak can be made equal to or less than 60° C.

As shown in FIG. 3 and the like, when the content of the potassium nitrate is set to 20% by weight or more, as compared with the cases of 10% and 15%, the range of the melting peak is more satisfactorily narrowed. In this regard, in the present embodiment, the content of the potassium nitrate is more preferably equal to or greater than 20% by weight. Hence, by setting the content of the potassium nitrate to 20% by weight or more, the range of the melting peak can be more satisfactorily narrowed.

It is often required to control the temperature of the battery 30 to a low temperature. In particular, when as in the present embodiment, the battery 30 is a lithium-ion battery including a liquid electrolyte, it is often required to control the temperature to 60° C. or less. In this regard, in the present embodiment, as described above, the melting peak of the heat storage material 20 for cooling the battery 30 is within a range of equal to or less than 60° C. Hence, the temperature of the battery 30 is easily controlled to 60° C. or less.

### [Variations]

For example, the embodiment described above can be changed as follows and practiced. The melting point adjuster 25 may be changed to potassium chloride or sodium nitrate. This is because as shown in FIG. 2, in case in which potassium chloride or sodium nitrate is used, it is possible to lower the melting point while ensuring the heat storage density of the heat storage material though the degree thereof is not as much as that of the potassium nitrate.

The battery 30 and the heat storage material 20 may be installed in moving bodies other than the electric vehicle 100 such as a ship or drone, or may be installed in fixtures. For example, the heat storage material 20 may be provided for products other than the battery 30 such as various types of circuits which generate a large amount of heat.

### EXPLANATION OF REFERENCE NUMERALS

20 Heat storage material
21 Sodium acetate trihydrate serving as main component
25 Potassium nitrate serving as melting point adjuster
30 Battery

What is claimed is:

1. A heat storage material comprising: sodium acetate trihydrate that serves as a main component; and
a melting point adjuster that is any one of potassium nitrate, potassium chloride or sodium nitrate,
the content of the melting point adjuster being equal to or greater than 10% by weight.

2. The heat storage material according to claim 1, wherein the melting point adjuster is the potassium nitrate.

3. The heat storage material according to claim 2, wherein the content of the potassium nitrate is equal to or greater than 20% by weight.

4. The heat storage material according to claim 1, wherein the heat storage material is a battery temperature rise suppression material that absorbs the heat of a battery to melt, thereby storing latent heat and suppressing an increase in a temperature of the battery.

5. The heat storage material according to claim 4, wherein the battery is a lithium-ion battery that includes a liquid electrolyte.
